(19) United States
(12) Patent Application Publication
(10) Pub. No.: US 2025/0344707 A1
(43) Pub. Date: Nov. 13, 2025

(54) AUTOMATED CRAWFISH PEELING DEVICE

(71) Applicant: University of Louisiana at Lafayette, Lafayette, LA (US)

(72) Inventors: Joshua VAUGHAN, Lafayette, LA (US); Andrew ALBRIGHT, Lafayette, LA (US); Brennan MOELLER, Lafayette, LA (US); Darcy LAFONT, Lafayette, LA (US); Dallas MITCHELL, Lafayette, LA (US)

(73) Assignee: University of Louisiana at Lafayette, Lafayette, LA (US)

(21) Appl. No.: 19/207,263

(22) Filed: May 13, 2025

Related U.S. Application Data
(60) Provisional application No. 63/646,584, filed on May 13, 2024.

(51) Int. Cl. A22C 29/02

(52) U.S. Cl. CPC A22C 29/025

(57) ABSTRACT

Disclosed herein is a system and method for processing crawfish, specifically peeling crawfish shells. The device comprises a meat extraction portion, further comprising a clamping subsystem, cutting subsystem, and extraction subsystem designed to extract the crawfish meat from the shell without human interference. In a preferred embodiment of the device, the device further comprises a head/tail separation portion designed to decapitate the crawfish without human interference. The device further incorporates a single-board computer comprising a machine-learning system and related image database designed for improved identification of the crawfish shell components by the device, resulting in greater accuracy in processing individual crawfish of varying sizes.

### CROSS-REFERENCE TO RELATED APPLICATIONS

This application claims priority to Provisional Application No. 63/646,584 filed on May 13, 2024.

### STATEMENT REGARDING FEDERALLY SPONSORED RESEARCH OR DEVELOPMENT

Not applicable.

### REFERENCE TO A “SEQUENCE LISTING,” A TABLE, OR A COMPUTER PROGRAM

Not applicable.

### FIELD OF THE INVENTION

The field of the invention is mechanical devices for processing crustaceans, and particularly relates to a method and device for obtaining crawfish meat.

### BRIEF DESCRIPTION OF THE DRAWINGS

The drawings constitute a part of this specification and include exemplary embodiments of the AUTOMATED CRAWFISH PEELING DEVICE, which may be embodied in various forms. It is to be understood that in some instances, various aspects of the invention may be shown exaggerated or enlarged to facilitate an understanding of the invention. Therefore, the drawings may not be to scale.

FIG. 1 is a drawing of the AUTOMATED CRAWFISH PEELING DEVICE.

FIG. 2 is a drawing of the AUTOMATED CRAWFISH PEELING DEVICE showing the locations of the cutting subsystem, clamping subsystem, and extraction system within the Meat Extraction Portion of the device.

FIG. 3 is a depiction of an embodiment of the core components of the AUTOMATED CRAWFISH PEELING DEVICE.

FIG. 4 is a drawing of an isolated view of the clamping subsystem.

FIG. 5A is a drawing of an isolated isometric view of an embodiment of a clamp in the clamping subsystem.

FIG. 5B is a drawing of an isolated front view of an embodiment of a clamp in the clamping subsystem.

FIG. 6 is a drawing of an isolated view of the cutting subsystem.

FIG. 7 is a drawing of isolated isometric view of the cutting subsystem interacting with the clamping subsystem.

FIG. 8 is a drawing of an isolated view of the extraction subsystem.

FIG. 9 is a drawing of the electrical backplane for an embodiment of the device.

FIG. 10 is a drawing of the stepper motors used in an embodiment of the device.

FIG. 11 is a drawing of the electrical connections for the stepper motors.

FIG. 12 is a drawing of the brushless DC motor controller for an embodiment of the device.

FIG. 13 is drawing of an embodiment of the graphical user interface.

FIG. 14 is a drawing of the tunable parameters on the clamps of the clamping subsystem.

FIG. 15 is a drawing indicating the tunable parameters on the extraction subsystem.

FIG. 16 is a drawing of an isolated cross-sectional view of an embodiment of the clamping subsystem components.

FIG. 17 is a rendering of an isolated view of an embodiment of the Head/Tail Separation Portion.

FIG. 18 is a rendering of an embodiment of the Automated Crawfish Peeling Device with both the Meat Extraction Portion and a Head/Tail Separation Portion.

### BACKGROUND OF THE INVENTION

Freshwater crustaceans, such as crawfish, are abundant in the swamps and marshes of South Louisiana. The annual yield of crawfish harvests ranges from 120 million to 150 million pounds, providing over $300 million annual in contribution to the Louisiana economy.

While crawfish are often sold live to food suppliers and individual consumers, which are then boiled and peeled by the purchasers, many persons who want to enjoy crawfish want to do so without the labor of peeling crawfish. Crawfish shells can be irregular, sharp, and requires significant labor for small amounts of meat. On average, it takes 7 pounds of crawfish in their shells to produce 1 pound of crawfish meat. Commercial crawfish producers still heavily rely on human labor to peel crawfish for packaging and sale. There exists a need in the marketplace for a faster and less human-labor-intensive mechanism to process crawfish for packaging and sale outside of the shells.

Currently known devices for automated crawfish peeling are deficient because devices currently available in the marketplace fail to account for inconsistent shapes and sizes of the crawfish and the tight curling of the crawfish tails after cooking. Recent studies explored the effects of the cooking method on the tightness of crawfish tail curling, and those studies determined that high-temperature, short duration cooking leads to tightly curled tails, whether the crawfish were pre-soaked in tenderizer, salted, sonicated, or frozen.

For easier processing through mechanical methods, prior methods tried to cook the crawfish in water that was lower than boiling (e.g., approximately 160° F.) until the tail meat reached 145° F. internal temperature. The lower temperature method cooked the crawfish but resulted in less tightly curled tails. While promising, peelers using lower-temperature-cooked crawfish struggled with variations in crawfish size and shape. Further, crawfish tails that are not tightly curled are less marketable, as there is concern with the quality and safety of non-curled crawfish tails.

The use of machine vision in robotics and automation has expanded greatly as both cameras and processors have declined in price. For example, machine visions systems have been used to monitor crane workspaces for obstacles, to track crane payloads for feedback control, and to map the terrain for an anti-landmine robot. In the food processing sphere, machine vision has been widely used to collect data on qualities such as the size, weight, shape, texture and color of food. See, e.g., Zhu, L. L. et al., Deep learning and machine vision for food processing: A survey, 4 CURRENT RES. IN FOOD SCI. 233 (2021). Machine learning and AI has seen rapid advancements in recent years. These advancements are at least partially driven by increases in computing power. In addition, major corporations have supported significant research in this area.

### SUMMARY OF THE INVENTION

In this work, a machine vision system was developed to achieve several objectives. It can be used to monitor the crawfish size and orientation as it begins its way through the peeling process. This will allow the system to compensate for a wide range of initial orientations and crawfish sizes. In a production environment, a separate camera could monitor the output of the system to estimate yield and track system performance, perhaps leading to operational improvements within the peeling facility. Cameras are also included internal to the system and can be used to guide the depth of cut and monitor the progress of crawfish through the device.

A wide body of literature is available that describes the trends in crawfish body shapes and sizes (morphometry) across several species of crawfish. This literature was combined with hands-on measurement of local crawfish to define the ranges of dimensions needed within the peeling system, which were determined to be approximately 5.80 cm-13.90 cm (representing a range encompassing +/−20% from the average measurements for each class of small, medium, and large crawfish in four seasons). From those ranges, a machine-learning based algorithm to isolate crawfish tails in images and videos was developed. A database comprising images collected by the inventors and synthetic data from computer renderings of crawfish was then used to train the algorithm.

### DETAILED DESCRIPTION OF THE INVENTION

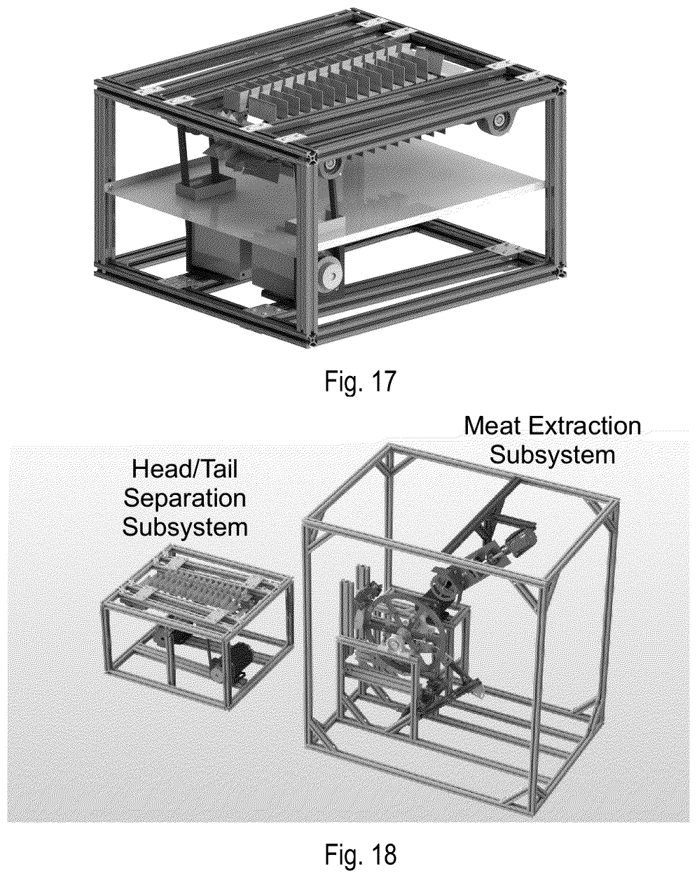

FIG. 18 shows CAD drawings of the complete system, comprising a Head/Tail Separation Portion 100, which separates the crawfish head from the tail, and a Meat Extraction Portion 200, which extracts the meat from the tail shell.

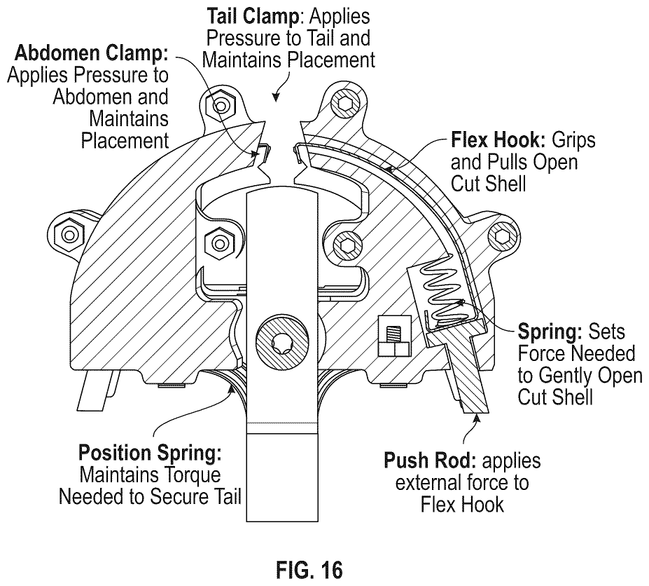

FIG. 17 shows a CAD drawing of the Head/Tail Separation Portion, comprising an enclosure frame to which a drive motor 30 is fixed and is operationally connected to a tail track 31, further comprising tail separation plates 35 protruding from the track and oriented perpendicularly to the motion of the track, that moves in one direction towards the crawfish tail exit 32 while a second drive motor 30 is fixed and is operationally connected to a second parallel head track 33, further comprising head separation plates 36 protruding from the track and oriented perpendicularly to the motion of the track and, which moves in the opposite direction from the tail track 31. When a whole crawfish enters the head/tail separation subsystem 100 at the crawfish entry 34, the head of the crawfish is moved backward by the head separation plates and motion of the head track while the tail is advanced forward to the crawfish tail exit by the tail separation plates and opposite motion of the parallel tail track, such that the crawfish is decapitated and the head portion is discarded at the crawfish entry and the tail portion advances to the crawfish exit for further processing in the Meat Extraction Portion.

In a preferred embodiment of the Head/Tail Separation Subsystem, the head separation plates 36 and tail separation plates 35 have an L-shape with the long side of the L perpendicular to the track motion on both tracks, and the short side of the L oriented to the interior of the system with the free edge pointing to the crawfish entry 34 such that the short free edge of the head separation plates 36 act as blades to assist with decapitation when the parallel tracks move in opposite directions, causing a crawfish positioned at the crawfish entry 34 to have its head moved backwards as the tail moves forwards toward the crawfish tail exit 32. The heads may be collected beneath the crawfish entry 34 for further processing or for discard. Meanwhile, the short free edge of the tail separation plates 35 prevent the newly severed tails from falling between the parallel tracks as the tails advance towards the crawfish tail exit 32.

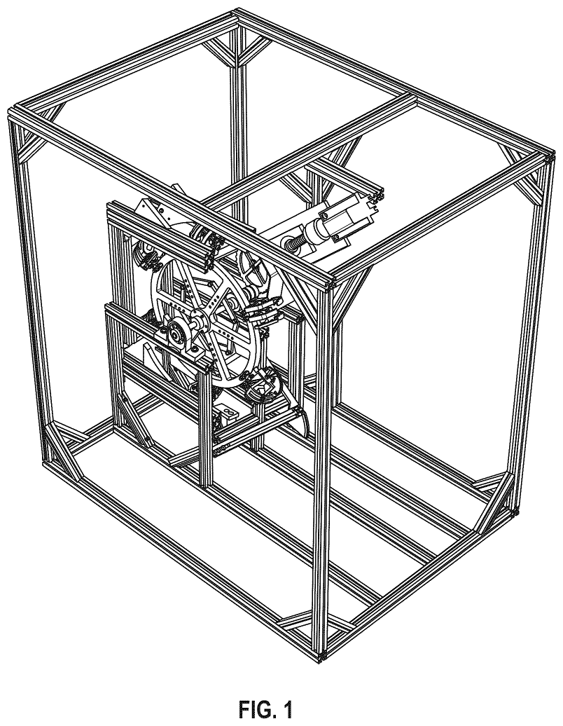

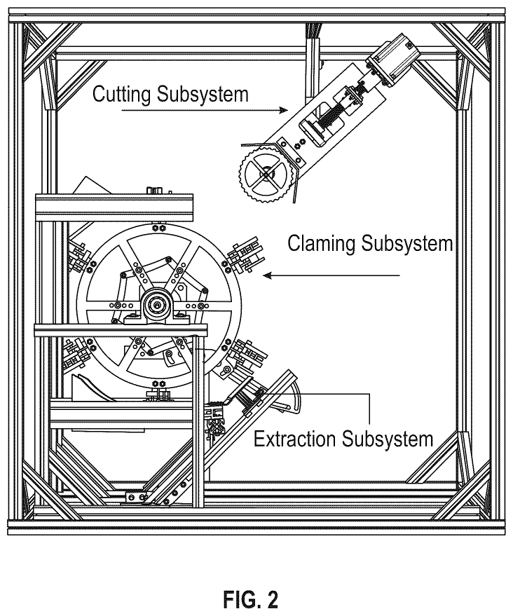

CAD drawings of the prototype Meat Extraction Portion design are shown in FIGS. 1 and 2. The Meat Extraction Portion 200 is further comprised of three key subsystems: the Clamping Subsystem 1, the Cutting Subsystem 2, and the Extraction Subsystem 3. These three subsystems are arranged by fixture to an exterior enclosure frame 26 such that a crawfish tail enters the Clamping Subsystem 1, then is acted upon by the Cutting Subsystem 2, and then finally by the Extraction Subsystem 3 whereby the meat is removed from the tail shell.

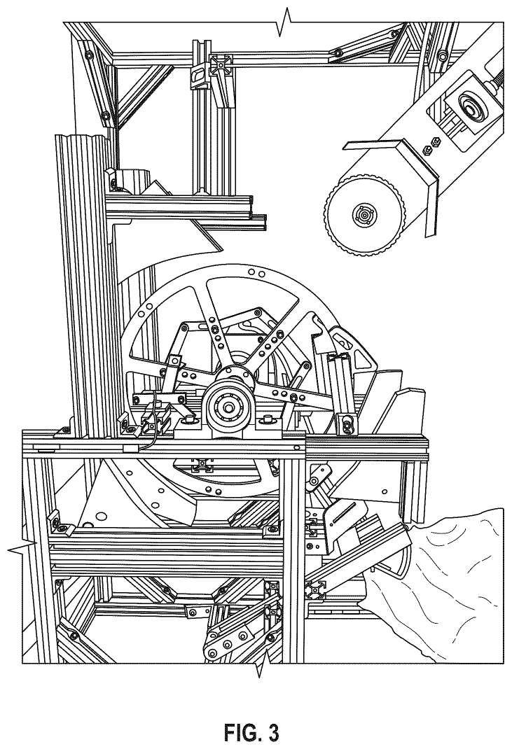

Both the Clamping Subsystem 1 and the Extraction Subsystem 2 are driven by a single actuator 4 via a tunable cam profile 5, reducing the requirements for external sensors. An image of the core components of the system is shown in FIG. 3. In the orientation of this and FIG. 2, the crawfish tail enters the system from the left side. However, other orientations are contemplated as well. There is a holding plate 6 there where the tail should be placed, either via a human operator or via an autonomous conveyance. In a preferred embodiment, the tail is placed on the holding plate via autonomous conveyance from the Head/Tail Separation Portion 100. The cam profile 5 opens the clamp 7 at this location, then closes it immediately after, clamping the exterior of the crawfish tail.

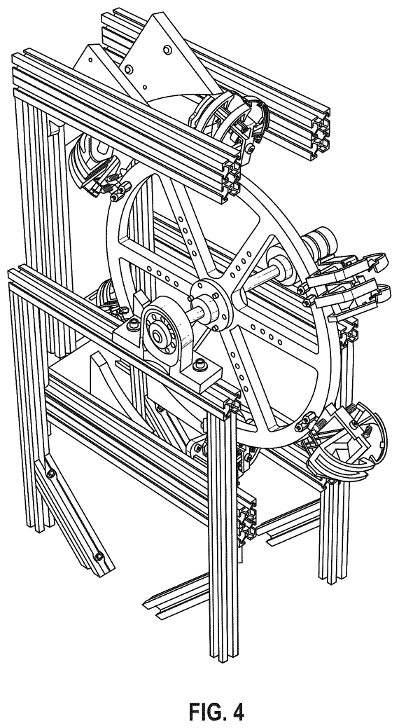

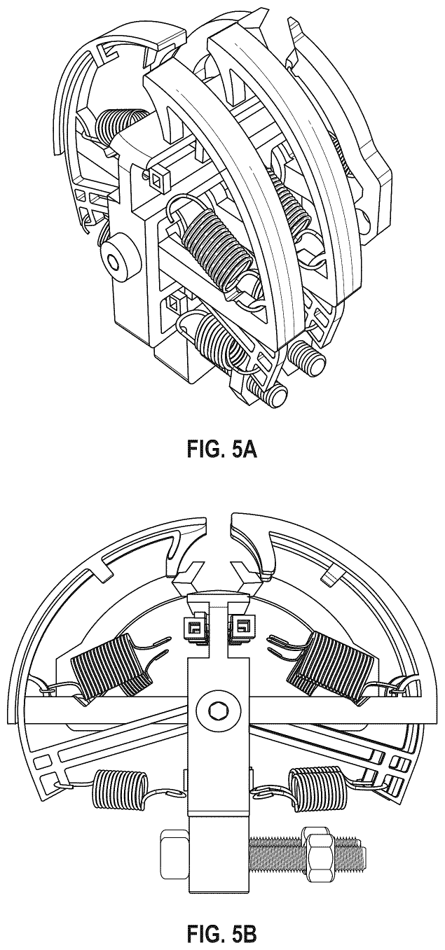

In the prototype system, six clamps 7 were placed on the exterior of the drive wheel 8, as shown in FIG. 4. The opening and closing of all is driven by the motion of the drive wheel 8 along a cam profile 5. CAD drawings of the clamp design itself are shown in FIG. 5. The prototype versions of the clamp 7 were designed to be highly configurable, leading to the design being slightly more complex than a production version would need to be.

The Clamping Subsystem 1 further comprises a multitude of clamps 7 which are attached to the exterior of the drive wheel 8. Each clamp 7 further comprises a plurality of abdomen clamps 24, tail clamps 25, and cam followers to open the clamps. The abdomen clamps 24 and tail clamps 25 are arranged along an abdomen rest plate 28, to which the abdomen clamps 24 and tail clamps 25 are attached via clamping springs 29 such that a crawfish tail placed in the clamp 7 with the belly side resting on the abdomen rest plate 28 will be securely gripped in the tail clamps 25 and abdomen clamps 24 by the spring force of the clamping springs 29. The plurality of cam followers 27 are arranged on the outside of the clamp 7 such that as the clamp moves with the rotation of the main drive wheel 8, the clamps open when the cam followers come into contact with the clamp opening guides 30 fixed along the path of rotation of the drive wheel 8, allowing a crawfish tail to be inserted or removed from the clamp.

In a preferred embodiment of the invention, each clamp 7 comprises four abdomen clamps 24 arranged two on each side of a rounded abdomen resting plate 28 and two tail clamps 25 arranged one on either side of said resting plate. The abdomen clamps and tail clamps are operationally connected to the rounded resting plate by position springs 29, such that the positional spring force causes the clamps 7 to remain in the closed position on a crawfish tail resting on the central rounded abdomen rest plate 28. In this embodiment, a flex hook 37 is located concentrically inside each abdomen clamp and is operationally connected to a hook spring 38 inside the base of each abdomen clamp, which hook spring sets the force needed to gently open the cut tail shell. A push rod 39 inserted in the base of the abdomen clamp applies external force to the flex hook

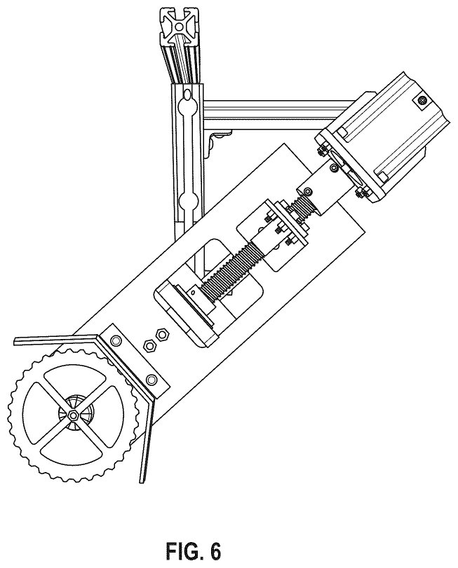

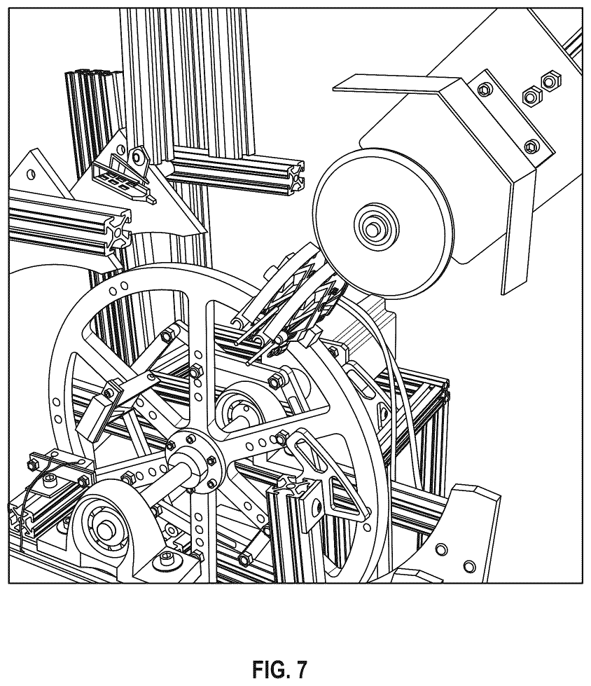

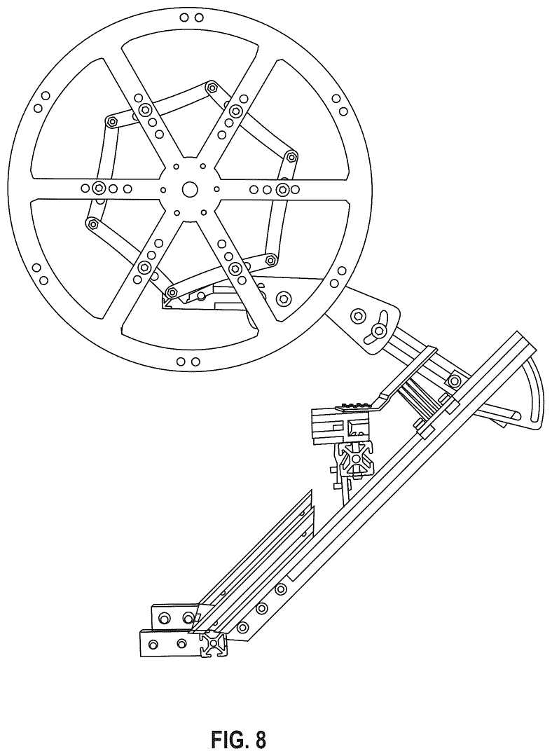

As the tail rotates in the clamp 7, it approaches the Cutting Subsystem 2, which is shown in isolation in FIG. 6. This is comprised of a surgical-grade, circular blade 9 mounted on a ball-screw driven axis 10. This allows the system to move to a programmable depth of cut as the crawfish tail passes. As mentioned previously, one of the internal cameras 11 can be used to determine the proper depth. FIG. 7 shows a tail being cut.

One the shell is cut, the crawfish continues to rotate on the main drive wheel 8, eventually reaching the Extraction Subsystem 3. This system is also driven by the main drive wheel 8, via a cam profile 5. This avoids needing additional sensors to locate the clamp 7 and crawfish as they approach. The cam profile 5 drives a short arm 12, the end of which has a series of forks 13. These forks 13 reach through the cut shell and grab the tail meat. As the drive wheel 8 continues to rotate, the meat is pulled from the shell. As it rotates further, the arm 12 retracts and the meat is released from the forks 13 and into a holding bin 14.

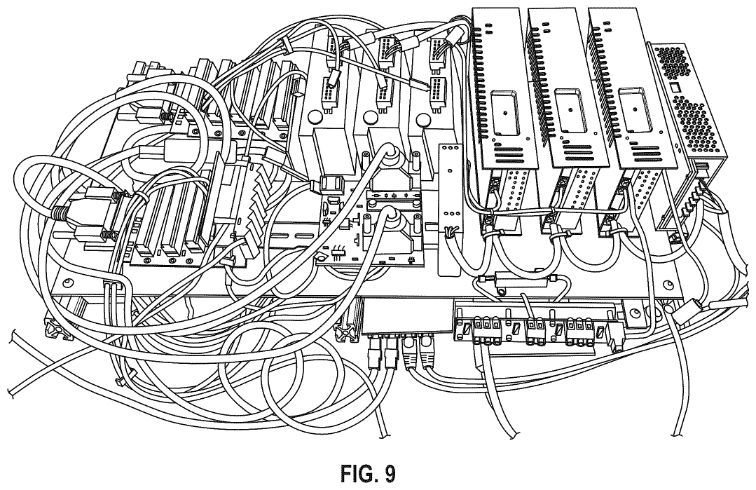

The electrical backplane 15 for the developed prototype is shown in FIG. 9. The core controller 16 for the system comprises a single-board computer with unique real-time control capabilities (hereinafter “CPU”) 17. It interfaces with three controllers 18, one brushless DC motor controller 19, and a User Interface 20. In one embodiment, each motor has an independent power supply 21.

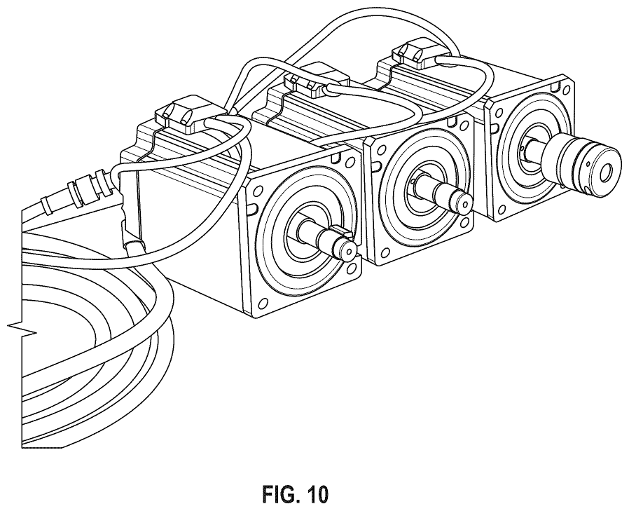

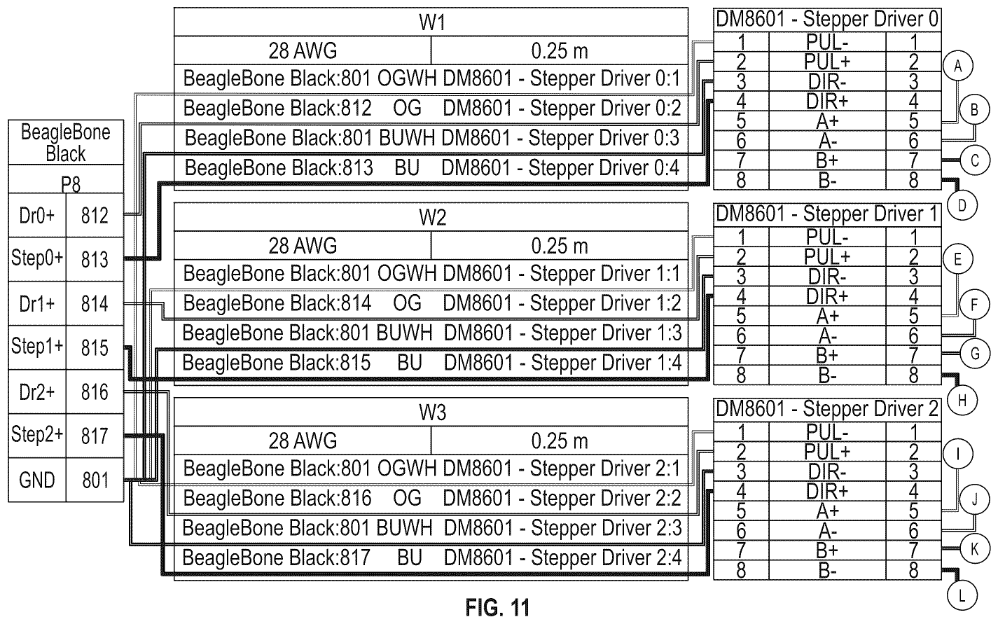

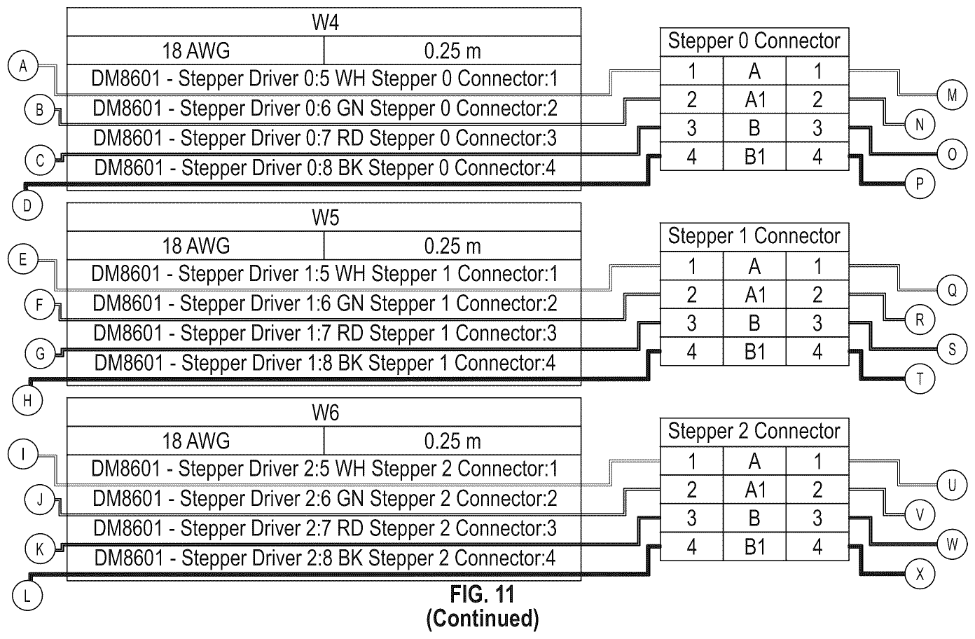

Two incorporated stepper motors are shown in isolation in FIGS. 10(a) and 10(b). One embodiment utilizes these stepper motors as controllers 18. However, in an alternate embodiment, AC motors are used instead of stepper motors. Other configurations with alternative types of motors are envisioned. The connections between the CPU 17, the motor drivers 22, and the motors 23 are shown in FIG. 11. In one embodiment, brushless DC motors are used to drive the motion of the cutter subsystem. In another embodiment, the driver for the brushless DC motors is industrially hardened.

The control system on the prototype design leverages a suite of free, open-source software, written in several different languages. The two main languages used were C++ and Python. Using these two languages, code was written within two open-source frameworks, MachineKit and ROS. MachineKit handles the low-level, realtime critical controls, such as ensuring stepper motor timing and enforcing safety limits. ROS is used for higher-level controls actions, acting in a supervisory manner. The machine vision pipelines and user interface also operate at the ROS level.

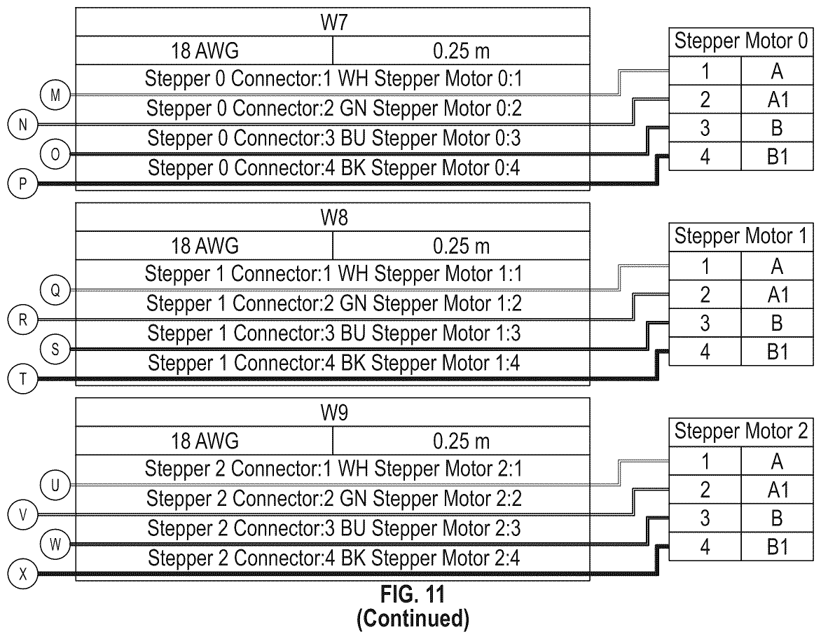

A user interface (UI) 20 was also developed for the system and is shown in FIG. 13. It is written much like a modern web-app and interfaces with the system hardware via a web interface. Communication with the hardware controllers 16, 18 is handled via websockets. The UI 20 shows the system state and the number of crawfish the system has peeled. The three cameras 11 mounted in the system for monitoring its operation are also shown in UI 20.

Because this UI is web-based, it can be run on an industrial tablet or a properly protected iPad or similar. It also means that one operator can easily check the status and manage multiple copies of the proposed system. In addition, the data collected can easily leverage the rich number of available database schema for web-based applications, helping operations management at facilities using this system.

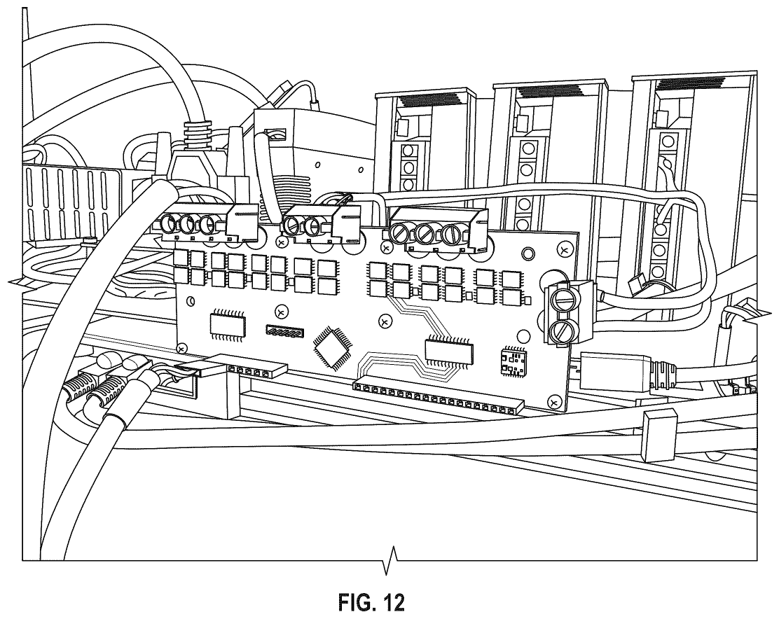

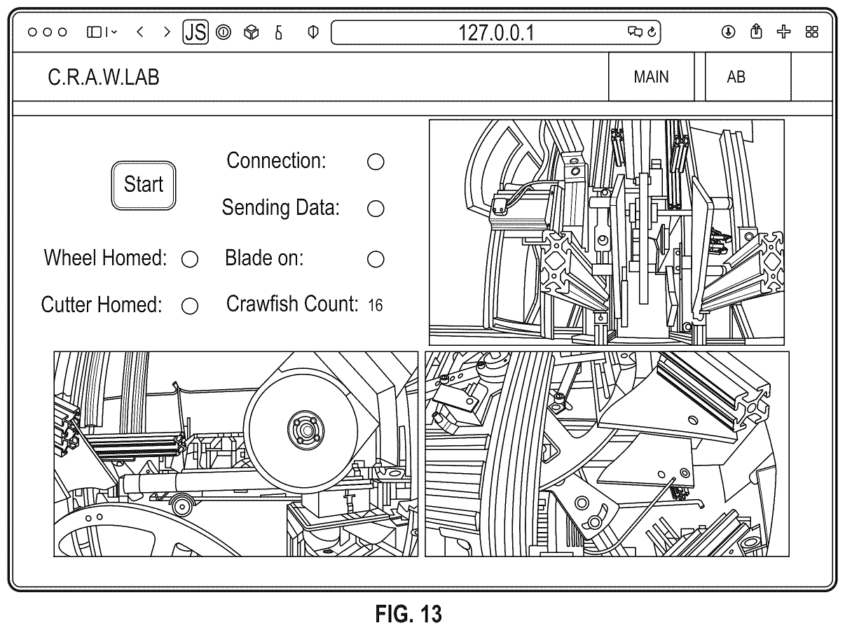

The prototype was designed in a way such that key parameters in its operation are easily tuned. These could be further refined and the variability limited for a production version, simplifying the design. The two tunable parameters for the clamp design are the tail clamping shape 7a and abdomen clamping radius 7b, as shown in FIG. 14. The clamping shape could be varied by having a series of inserts. In one embodiment, a 3D printer was used to quickly re-print those sections of the clamp, as needed.

The key tunable parameters on the extraction system 3 are shown in FIG. 17. This is the system that contains the cam profile 5 that powers the entire system. That profile could be refined and the variability in it limited in a production further, again simplifying the overall design and reducing costs. That cam profile also drives the other two key tunable parameters, the extraction profile and its timing.

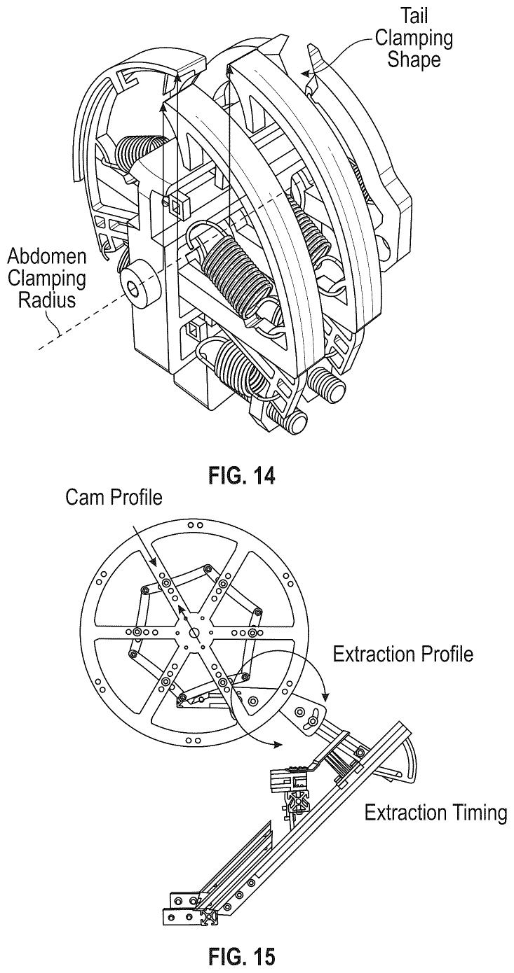

In an embodiment, a machine-learning, artificial intelligence (AI), system and related image database was also developed. The system is designed to find crawfish heads and tails in any image (or video) that is fed to it. To complete this task, images were scraped from the internet, and the heads and tails in them were manually labeled. This was then fed to a machine-learning-based segmentation algorithm for training. A variety of existing segmentation algorithms were tested, such as Mask R-CNN and Detectron2, each retrained for this crawfish segmentation task. This demonstrates the system's ability to leverage the state-of-the-art in image segmentation. The performance of the state-of-the-art segmentation algorithms has gotten significantly better even in the short time since this project began. Some of the manually labeled images in the database are shown in FIG. 16. This functionality can be used to inform the clamping and cut depth within the processing system, track system performance over time, and track overall production facility performance over time.

In addition to the machine-learning-based segmentation method and database, a conventional machine vision pipeline (i.e. not based on machine learning or AI) was developed to segment crawfish tails from the background. On example frame from a video of this pipeline is shown in FIG. 19. The black band in the middle of the image shows the algorithm at work; the tails have been segmented from the remainder of the image. Like the machine-learning enabled segmentation method, this could be used to track tails through the system, providing valuable data on both system performance and overall production facility operations.

While the disclosures in this application have largely been described for use in processing crawfish, a person having ordinary skill in the art would understand that the disclosed system and method could be used to also process shrimp or lobster meat as well.

The subject matter of the present invention is described with specificity herein to meet statutory requirements. However, the description itself is not intended to necessarily limit the scope of claims. Rather, the claimed subject matter might be embodied in other ways to include different steps or combinations of steps like the ones described in this document, in conjunction with other present or future technologies. Although the terms “step” and/or “block” or “module” etc. might be used herein to connote different components of methods or systems employed, the terms should not be interpreted as implying any specific order among or between various steps herein disclosed unless and except when the order of individual steps is explicitly described.

Furthermore, the described features, structures, or characteristics may be combined in any suitable manner in one or more embodiments. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Moreover, the terms “substantially” or “approximately” as used herein may be applied to modify any quantitative representation that could permissibly vary without resulting in a change to the basic function to which it is related.

We claim:

1. A device for extracting meat from crustaceans comprising:
a main drive wheel;
a clamping subsystem;
a cutting subsystem;
an extraction subsystem;
a user interface.

2. The device of claim 1, further comprising a head/tail separating portion.

3. The device of claim 2 wherein said head/tail separating portion further comprises:
adjacent parallel tracks, each driven by a motor;
dividing plates protruding perpendicularly from the surface and to the directions of motion of each track.

4. The device of claim 1, wherein the cutting system comprises:
a blade;
a driven axis; and
at least one internal camera.

5. The device of claim 2, wherein the cutting system comprises:
a blade;
a driven axis; and
at least one internal camera.

6. The device of claim 1, wherein the clamping subsystem comprises a holding plate and at least two clamps, wherein the number of clamps comprising the clamping system are variable depending on a user's preferred calibration.

7. The device of claim 2, wherein the clamping subsystem comprises a holding plate and at least two clamps, wherein the number of clamps comprising the clamping system are variable depending on a user's preferred calibration.

8. The device of claim 6, wherein the clamping subsystem further comprises at least two flex hooks.

9. The device of claim 2, wherein the clamping subsystem comprises a holding plate and at least two clamps, wherein the number of clamps comprising the clamping system are variable depending on a user's preferred calibration, and wherein the clamping subsystem further comprises at least two flex hooks.

10. The device of claim 1, wherein the extraction system comprises at least one fork.

11. The device of claim 2, wherein the extraction system comprises at least one fork.

12. A method for extracting meat from a crustacean comprising:
(a) cooking the crustacean, wherein the crustacean comprises a shell, comprising a head section and a tail section, and meat contained inside of the tail section;
(b) placing the crustacean in an extraction device comprising:
a main drive wheel;
a holding plate, comprising at least two clamps;
a clamping subsystem;
a cutting subsystem; and
an extraction system;
(c) clamping the crustacean to the holding plate;
(d) cutting the tail section using the cutting subsystem;
(e) moving the crustacean on the main drive wheel to the extraction subsystem, wherein the extraction subsystem comprises a plurality of forks;
(f) grabbing the meat of the crustacean using the plurality of forks;
(g) pulling the meat from the shell by rotating the main drive wheel; and
(h) releasing the meat from the plurality of forks into a holding bin.
